(19) United States
(12) Patent Application Publication
(10) Pub. No.: US 2015/0256551 A1
(43) Pub. Date: Sep. 10, 2015

(54) LOG ANALYSIS SYSTEM AND LOG ANALYSIS METHOD FOR SECURITY SYSTEM

(71) Applicant: Myoung Hun KANG, (US)

(72) Inventor: Myoung Hun Kang, Daejeon (KR)

(21) Appl. No.: 14/422,023

(22) PCT Filed: Aug. 22, 2013
(86) PCT No.: PCT/KR2013/007538

§ 371 Date: May 22, 2015

(30) Foreign Application Priority Data
Oct. 5, 2012 (KR) 10-2012-0110947

(51) Int. Cl. H04L 29/06; H04L 29/08

(52) U.S. Cl. CPC H04L 63/1416; H04L 67/10; H04L 67/02

(57) ABSTRACT

A log analysis system and method for a security system, which allow the security system monitoring communications between general systems to generate logs according to a predetermined rule and store the same in a log database are disclosed. A log analyzer determines whether log information containing attack content in the log database exists, and if log information containing attack content exists, sorts the log information by attack name. The log analyzer determines whether the attack content data of the log information sorted by attack name is based on a web request or not, and if the attack content data is based on a web request, performs HTTP-indicator-based text normalization. The log analyzer performs rule-pattern-based text normalization after the HTTP-indicator-based text normalization. According to an embodiment of the present invention, a quantitative basis for increasing an amount and accuracy of analysis and therefore improving accuracy of rules in the future can be established by making improvements to the conventional log analysis methods for security systems so that an operator or log analyst may discover a hacking attack in a timely manner.

### TECHNICAL FIELD

The present invention relates to a security system, and more particularly, to a log analysis system and method for a security system.

### BACKGROUND ART

In general, companies and government agencies keep important information in internal information systems or computers, and external or internal users have access to and use of such information.

As such information is important for security reasons, companies and government agencies perform monitoring using security systems.

Data leaks due to hacking into many companies like Auction, Hyundai Capital, SK Communications, Nexon, and EBS are increasing more and more. What all of such leaks have in common is that these companies failed to discover the hacking attacks in a timely manner, even though they used security systems such as intrusion detection, intrusion prevention, web firewalls, etc.

In a security system, a specific pattern of hacking attack or other suspicious activity is predefined as a rule, and the rule's pattern is compared with a traffic pattern. If they are the same, a log is created, along with a detection or prevention process depending on the features of the security system.

However, because an attack and normal traffic are both represented by the same range of patterns (characters like the alphabet or symbols like numbers), they may incidentally have the same pattern even though they mean different things as a whole.

For this reason, the name and content of an attack, which are the components of a log, need to be checked on a one-to-one basis, in order to check whether the log is created about hacking or not. Since this requires humanlike judgment, if a huge amount of logs are created, it is impossible to check all the logs due to lack of labor. As such, as in the aforementioned example of an accident, an operator or log analyst may not discover and prevent a hacking attack in a timely manner.

For reference, rule types are generally classified as in the following Table 1, and the number of rules varies for different manufacturers of security systems, but is generally 1000 to 3000.

TABLE 1

| | | Examples of attack names for |
|---|---|---|
| Rule types | Descriptions | the rules |
| Intrusion attacks | These are a type of attacks against which | sql injection (an attack causing |
| | measures must be taken, including leaks of | a database to malfunction), |
| | information within systems or other illegal | malicious code by iframe (an |
| | activities using a variety of attacking tools, like | attack causing infection with a |
| | webshells, backdoors, etc., or commands, | malicious code), |
| | unpermitted access attempts, attempts to steal | remote file inclusion (an |
| | passwords by protocol analysis, intrusion | webshell execution attack), etc. |
| | attempts exploiting buffer overflow | |
| | vulnerabilities. | |
| Information | These are attacks for gathering vulnerabilities of | top port scan, |
| gathering | a network or system, which occur right before | udp port scan, |
| attacks | hacking is done. Through these attacks, the | icmp pin scan, etc. |
| | versions, vulnerabilities, etc. of applications | |
| | running on a system's OS or open ports can be | |
| | discovered. | |
| Denial-of-service | These are a type of attacks that induce a | top syn flooding, |
| attacks | tremendous amount of network traffic with the | udp flooding, |
| | intention of paralyzing a particular server, which | icmp flooding, etc. |
| | do not cause damage like information leaks but | |
| | could bring business operations to a complete | |
| | halt. | |
| Others | Types of attacks that have little chance of happening | Use of qq (messenger developed |
| | but need to be brought to attention, including p2p or | in China), |
| | file sharing sites, which are non-business-related. | Fire sharing via torrents, etc. |

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a log analysis system and method for a security system which establish a quantitative basis for increasing an amount and accuracy of analysis and therefore improving the accuracy of rules in the future, by making improvements to the conventional log analysis methods for security systems so that an operator or log analyst may discover a hacking attack in a timely manner.

### Technical Solution

An exemplary embodiment of the present invention provides a log analysis system including:

a log database storing log information;

a security system that monitors communications between external general systems, generates the log information according to a predetermined rule of security, and stores the same in the log database;

a log analyzer that collects log information containing attack content from the log information stored in the log database, sorts the same by attack name, and if the attack content data is based on a web request, performs HTTP-indicator-based text normalization and then rule-pattern-based text normalization; and

a log screen that displays log information normalized by the log analyzer according to an administrator's request.

If the attack content data is not based on a web request, the log analyzer performs rule-pattern-based text normalization.

The log analyzer may include:

a log collector that collects log information having attack content from the log information stored in the log database and sorts it by attack name;

an HTTP-indicator-based text normalization processor that, if the attack content data is based on a web request, performs HTTP-indicator-based text normalization; and

a rule-pattern-based text normalization processor that, if the attack content data is not based on a web request or the attack content data is normalized based on HTTP indicators, performs rule-pattern-based text normalization.

An exemplary embodiment of the present invention provides a log analysis system for a security system which analyzes logs the security system generates according to a predetermined rule and stores them in a log database, the log analysis system including;

a log analyzer that collects log information containing attack content from the log information stored in the log database, sorts the same by attack name, and if the attack content data is based on a web request, performs HTTP-indicator-based text normalization and then rule-pattern-based text normalization; and a log screen that displays log information normalized by the log analyzer according to an administrator's request.

An exemplary embodiment of the present invention provides a log analysis method for a security system, which allows the security system monitoring communications between general systems to generate logs according to a predetermined rule and store the same in a log database, the log analysis method including: determining whether log information containing attack content exists in the log database by a log analyzer; if log information containing attack content exists, sorting the log information by attack name; determining whether the attack content data of the log information sorted by attack name is based on a web request or not; if the attack content data is based on a web request, performing HTTP-indicator-based text normalization; and performing rule-pattern-based text normalization after the HTTP-indicator-based text normalization.

The method further includes displaying log information normalized by the log analyzer according to an administrator's request.

The method further includes: if the attack content data is not based on a web request, performing rule-pattern-based text normalization by a log analyzer.

In the performing of HTTP-indicator-based text normalization if the attack content data is based on a web request, the attack content data is normalized into URI, User-Agent, Referer, and Host based on HTTP indicators.

According to an embodiment of the present invention, a log analysis system and method for a security system which establish a quantitative basis for increasing the amount and accuracy of analysis and therefore improving the accuracy of rules in the future by making improvements to the conventional log analysis methods for security systems so that an operator or log analyst may discover a hacking attack in a timely manner is provided.

### Advantageous Effects

### DESCRIPTION OF THE DRAWINGS

FIG. 1 is a block diagram of a log analysis system according to an exemplary embodiment of the present invention.

FIG. 2 is a view showing a structure of a security system log and a structure of a corresponding network packet.

FIG. 3 is a flowchart of data processing for log analysis according to an exemplary embodiment of the present invention.

FIG. 4 is a conceptual diagram of a 1:1 structure of attack names and attack content of logs in a security system.

FIG. 5 is a conceptual diagram of a 1:N structure of attack names and attack content of logs in a security system.

FIG. 6 is a conceptual diagram of attack content text before text normalization.

FIG. 7 is a conceptual diagram of attack content text after text normalization.

FIG. 8 is a block diagram of a 1:N correspondence between attack names and attack content according to an exemplary embodiment of the present invention.

FIG. 9 is an illustration of text normalization of attack content based on HTTP indicators according to an exemplary embodiment of the present invention.

FIG. 10 is an illustration of final text normalization based on HTTP indicators and an attack pattern according to an exemplary embodiment of the present invention.

FIG. 11 is a block diagram of a 1:N correspondence between attack names and attack content of logs that are not created during a web request process.

FIG. 12 is an illustration of attack-pattern-based text normalization performed on logs that are not created during a web request process.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

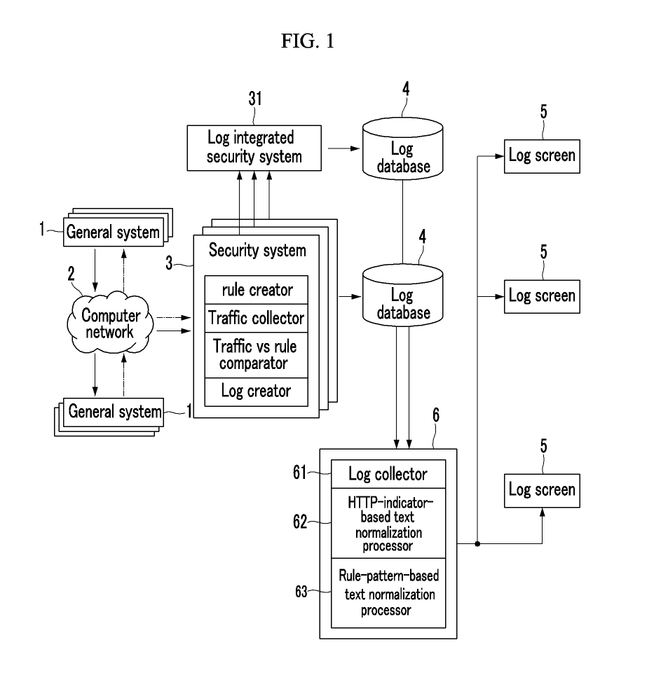

FIG. 1 is a block diagram of a log analysis system according to an exemplary embodiment of the present invention.

Referring to FIG. 1, a log analysis system according to an exemplary embodiment of the present invention includes:

a log database 4 storing log information;

a security system 3 that monitors communications between external general systems 1 and generates the log information according to a predetermined rule of security and stores it in the log database; and

a log analyzer 6 that collects log information containing attack content from the log information stored in the log database 4, sorts it by attack name, and if the attack content data is based on a web request, performs HTTP-indicator-based text normalization and then rule-pattern-based text normalization. If the attack content data is not based on a web request, the log analyzer 6 performs rule-pattern-based text normalization.

The log analyzer 6 includes: a log collector 61 that collects log information having attack content from the log information stored in the log database 4 and sorts it by attack name; an HTTP-indicator-based text normalization processor 62 that, if the attack content data is based on a web request, performs HTTP-indicator-based text normalization; and a rule-pattern-based text normalization processor 63 that, if the attack content data is not based on a web request or the attack content data is normalized based on HTTP indicators, performs rule-pattern-based text normalization. For reference, a security system's rule pattern consists of one or more essential patterns and one or more auxiliary patterns. A rule pattern based on which normalization shall be performed consists only of one or more essential patterns, and numerous modifications may be made to it if necessary.

A log screen 5 is a system for making a log query, and displays log information normalized by the log analyzer 6 according to an administrator's request. The log screen 5 may be a console for an administrator, and serves as a means for reading and analyzing logs. The log analyzer 6 and the log screen 5 may be realized by their own software and systems, or may be integrated with the conventional security systems and log screens.

General systems 1 are systems such as a PC, a server, or a router, and various information is sent and received to and from them.

A computer network 2 connects the general systems 1.

A log integrated security system 31 integrates and collects logs in various types of security systems 3 for inspecting hacking traffic flowing through a computer network, and such a log integration security system 31 is optional.

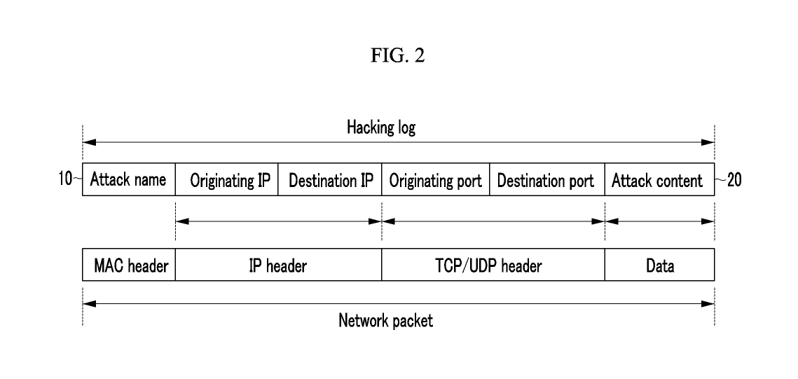

For reference, a structure of a hacking log is as shown in FIG. 2. Referring to FIG. 2, a network packet typically consists of a MAC header, an IP header, a TCP/UDP header, and data, whereas a hacking log has attack content 20 in the data part (an attack name 10 is chosen at random by a security system rule author as far as it represents a feature of the attack content 20).

An operation of the log analysis system having the above configuration according to the exemplary embodiment of the present invention will be described below.

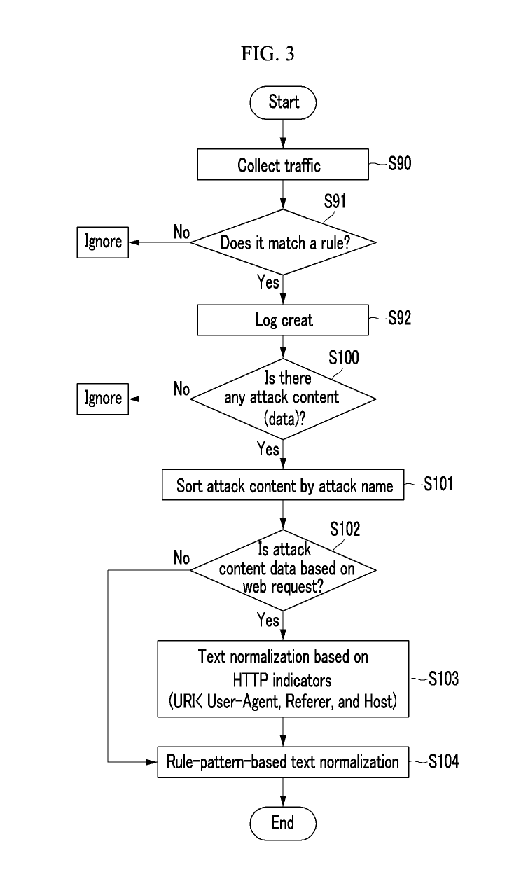

FIG. 3 is a flowchart of data processing for log analysis according to an exemplary embodiment of the present invention, which shows a process of sorting attack content 20 by attack name 10 and then normalizing text of the attack content 20.

Referring to FIG. 3, the security system 3 collects traffic between the general systems 1 (S90).

Next, the security system 3 determines whether the collected traffic matches a predetermined rule (S91).

If the collected traffic matches a predetermined rule, the security system 3 creates and stores log information in the log database 40 (S92).

If necessary, the log integrated security system 31 may sort log information in a number of security systems 3 and store it.

In this instance, the log collector 61 of the log analyzer 61 determines whether attack content exists in the log information stored in the log database 4 (S100).

If attack content exists, the log collector 61 sorts the attack content by attack name (S101).

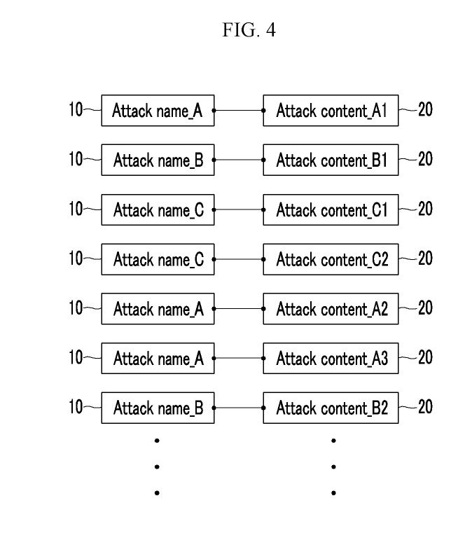

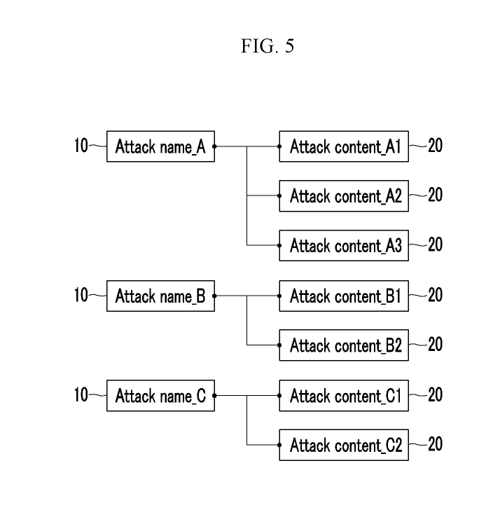

An example of this will be described with reference to FIG. 4 and FIG. 5. FIG. 4 illustrates a 1:1 analytic structure of attack names 10 and attack content 20 stored in the log database 4. FIG. 5 illustrates a 1:N structure in which the attack names 10 and attack content 20 of logs having a 1:1 structure as illustrated in FIG. 4 are sorted by attack name.

As illustrated in FIG. 4, logs created by the security system 3 are on a one-to-one basis. For analysis of logs having this structure, the attack names 10 and the attack content 20 must be analyzed one by one. Since there is no limit on the amount of log creation, there may be more unanalyzable logs as more logs are created. However, as illustrated in FIG. 5, if the attack names 10 and attack content 20 of logs are in a 1:N structure, this is beneficial in that, no matter how many logs are generated, as many logs as the attack names 10 are to be analyzed since the number of attack names 10 is limited by a predetermined rule.

Once log information is sorted, an HTTP-indicator-based text normalization processor determines whether attack content data is based on a web request or not (S102).

If the attack content data is based on a web request, the HTTP-indicator-based text normalization processor performs HTTP-indicator-based text normalization (S103). This is to perform normalization based on indicators specified in the Hypertext Transfer Protocol (HTTP) by using the fact that hacking occurs most of the time when a hacker transmits data to a web server, i.e., during a web request process (data starts with a string GET, POST, PUT, or DELETE). In this case, there are four types of HTTP indicators, including URI, Referer, Host, and User-Agent, on which normalization is performed. Though there are various types of indicators, it is possible to determine what data (URI) is transmitted from where (Referer) to where (Host) using what tool (User-Agent).

This process will be described in detail.

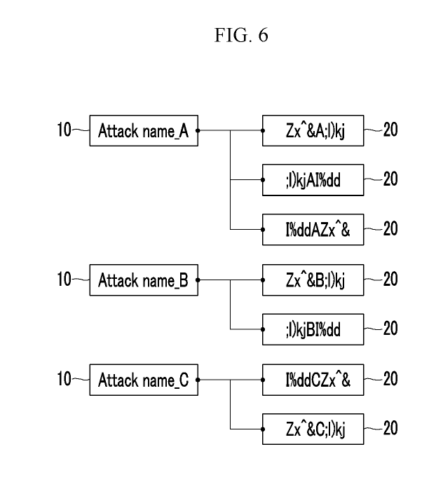

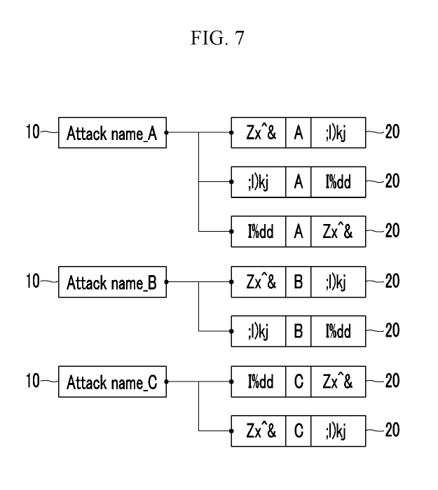

FIGS. 6 and 7 illustrate the concept of text normalization that applies the same classification rule to randomly distributed text of attack content 20. Referring to FIG. 6 and FIG. 7, the basic concept is that attack content is divided by attack name so that hacking can be discovered with ease.

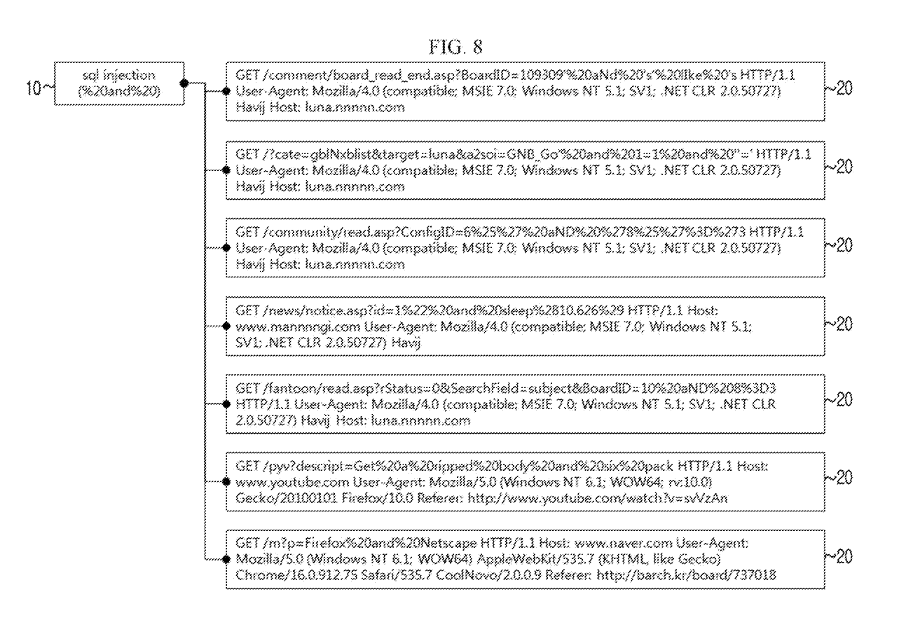

FIG. 8 shows an exemplary embodiment in which the attack content-containing log collector 61 chooses only logs containing attack content from the log database 4 (S100), and then completes a 1:N structure of attack names 10 and attack content 20 (S101). In this case, the method of sorting the attack content 20 by attack name 20 in logs containing the attack content may vary with the structure of the log database 4, but generally executes the following database commands (S100 and S101).

select ‘attack content column’, count(‘attack content column’)

from ‘log table’

where ‘attack name column’=‘attack name’ and ‘attack name column’ is not null

group by ‘attack content column’

When the attack content 20 is sorted by attack name, text of the attack content 20 is classified, i.e., normalized, according to classification criteria.

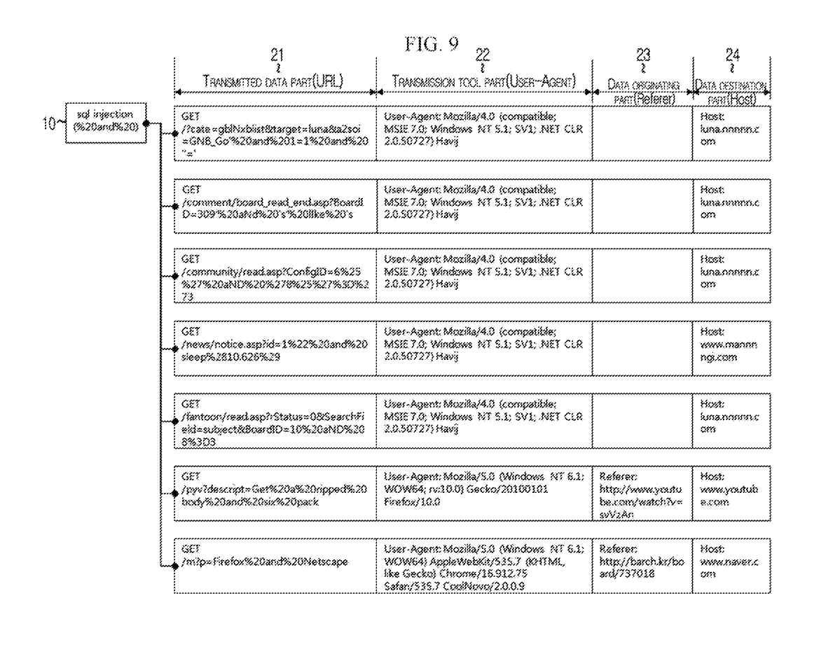

FIG. 9 shows an exemplary embodiment in which data of attack content 20 of a log starts with a ‘GET’ string, i.e., it is created during a web request process (S102), and then the HTTP-indicator-based text normalization processor 62 normalizes the attack content text into a transmitted data part 21, a transmission tool part 22, a data originating part 23, and a data destination part 24, based on HTTP indicators (URI, User-Agent, Referer, and Host) (S103).

Through the normalization, it is possible to collectively check the overall situation regarding creation of the attack content 20, i.e., what data (URI) is transmitted from where (Referer) to where (Host) using what tool (User-Agent). Although such a string as ‘GET’ corresponds to a ‘web request method indicator’, it is included in the ‘transmitted data part 21’ corresponding to the ‘URI indicator’ at the time of text classification since it plays an important role in detecting traffic characteristics.

For reference, the transmitted data part 21 corresponds to transmitted data (URI) in attack content of a log created during a web request process. The transmission tool part 22 corresponds to transmission tool (User-Agent) in the attack content of the log created during the web request process. The data originating part 23 indicates a data start (Referer) in the attack content of the log created during the web request process. The data destination part 24 indicates a data destination (Host) in the attack content of the log created during the web request process.

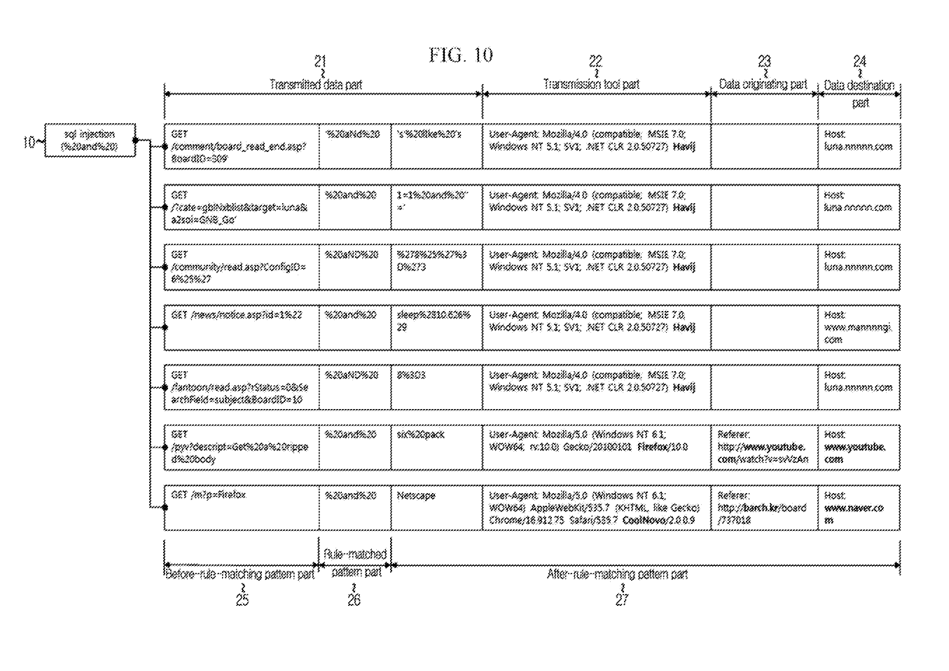

Next, the rule-pattern-based text normalization processor 63 performs rule-pattern-based text normalization on the attack content data normalized based on HTTP indicators (S104). This is shown in FIG. 10.

FIG. 10 shows an exemplary embodiment in which the text of attack content 20 normalized based on HTTP indicators is normalized once more into a before-rule-matching pattern part 25, a rule-matched pattern part 26, and an after-rule-matching pattern part 27, based on a rule pattern (S104). An operator or log analyst makes a query about and analyzes logs of such formats as shown in FIG. 10, through the log screen 5.

The before-rule-matching pattern part 25 is a pattern in the attack content text that is generated before rule application, the rule-matched pattern part 26 is a pattern in the attack content text that is compared with a rule, and the after-rule-matching pattern part 26 is a pattern in the attack content text after rule application.

For reference, a description will be made with a real example of hacking information. Part of the technology to be described below is a general technology an operator or log analyst uses for log analysis for a security system.

‘sql injection’ shown in FIG. 10 is an attack attempting to forge/falsify and leak information by inserting database commands into data transmitted to a web server. The illustrated example shows logs created when rule patterns apply to a ‘%/20and%20’ string. The logs \hat{1} to \hat{5} are attack logs, and the logs \hat{6} to \hat{7} are non-attack logs.

For reference, ‘%20’ refers to a ‘space’ to which a character is converted by ‘URL encoding’ due to the rule specifying that data (URL address) transmitted to a web server must not contain a space. Web servers and web browsers automatically convert various special symbols into a ‘%a pair of digits’ format.

First, a description will be made with reference to a rule pattern. The original attack content of the log \hat{1} before text normalization shown in FIG. 10 is as follows.

GET /?cate=gblNxblist&target=luna&a2soi=
GNB_Go‘%20and%201=1%20and%20’‘=’ HTTP/1.1
User-Agent: Mozilla/4.0 (compatible; MSIE 7.0;
Windows NT 5.1; SV1; .NET CLR 2.0.50727)
Havii Host: luna.nnnnn.com

An operator or log analyst should read the text of such attack content from start to finish to discover a rule pattern and determine what meaning this pattern has in the entire text.

Below is a ‘text-normalized log screen 5’ which appears after performing text normalization on the original attack content of the log \hat{1} as shown in FIG. 10.

| | | | | |
|---|---|---|---|---|
| GET | %20and%20 | 1=1%20and%20′ ‘=’ | User-Agent: | Host: |
| /?cate=gblNxb | | | Mozilla/4.0 | luna.nnnnn.com |
| list&target=1 | | | (compatible; MSIE | |
| una&a2soi=GNB_Go′ | | | 7.0; Windows NT | |
| | | | 5.1; SV1; .NET CLR | |
| | | | 2.0.50727) Havi j | |

Data transmitted to a web server has a ‘GET/path/webpage?variable=variablevalue’ form. An ‘sql injection’ attack is made in such a manner that a ‘variable=variablevalue’ format is modified to contain database commands. A typical example of this attack is to cause a database to malfunction by exploiting logical operations based on ‘true’ and ‘false’, like ‘1=1(true)’ or ‘8=3(false)’.

It can be seen that the text-normalized log \hat{1} is a modified attack log with a GET/?cate=gblNxblist&target=luna&a2soi=GNB₋Go’ format in which an ‘and’ string joins a normal ‘GET/path/webpage?variable=variablevalue’ format and a logical command ‘1=1’.

The operator or log analyst only needs to find out what meaning a rule pattern has in the entire text, without having to search the full attack content text for each rule pattern one by one.

Now, the non-attack log \hat{7} will be described. Below is the original attack content of the log \hat{7} before text normalization shown in FIG. 10.

GET /m?p=Firefox%20and%20Netscape HTTP/1.1 Host:
www.naver.com User-Agent: Mozilla/5.0
(Windows NT 6.1; WOW64) AppleWebKit/535.7
(KHTML, like Gecko) Chrome/16.0.912.75
Safari/535.7 CoolNovo/2.0.0.9 Referer: http://barch.kr/board/737018

Similarly to the log \hat{1}, the operator or log analyst normally should read the text of the attack content from start to finish to discover a rule pattern, and find out what meaning this pattern has in the entire text. However, using the ‘text-normalized log screen 5’ shown in FIG. 10, the operator or log analyst only needs to determine what meaning a rule pattern has in the entire text, without having to search the full attack content text for each rule pattern one by one.

| | | | | | |
|---|---|---|---|---|---|
| GET | %20and%20 | Netscape | User-Agent: Mozilla/5.0 | Referer: | Host: |
| /m?p=Firefox | | | (Windows NT 6.1; WOW64) | http://barch. | www.naver.com |
| | | | AppleWebKit/535.7 | kr/board/7370 | |
| | | | (KHTML, like Gecko) | 18 | |
| | | | Chrome/16.912.75 | | |
| | | | Safari/535.7 | | |
| | | | CoolNovo/2.0.0.9 | | |

The text-normalized log \hat{7} is used for a Firefox and Netscape format in which the ‘and’ string properly joins characters used as the values of variables. That is, this log is a non-attack log.

Now, a description will be made with reference to HTTP indicators. The ‘transmitted data part 21’ is an HTTP indicator that indicates data (URI) transmitted to a web server, the ‘transmission tool part 22’ is an HTTP indicator that indicates a tool (User-Agent) used for data transmission, the ‘data originating part 23’ is an HTTP indicator that indicates a source (Referer) of transmitted data, and the ‘data destination part 24’ is an HTTP indicator that indicates a destination (Host) of transmitted data.

All of the logs \hat{1} to \hat{5} identified as attacks in the description made with reference to a rule pattern use the ‘transmission tool 22’ called Mozilla/4.0 (compatible; MSIE 7.0; Windows NT 5.1; SV1; .NET CLR 2.0.50727) Havij. That is, data was transmitted to a web server by using a tool called ‘Havij (a tool for checking for web vulnerabilities, also used as a hacking tool), without using a usual web browser tool (Explorer, Firefox, Chrome, Safari, etc.). Also, the ‘data originating part 23’ is empty.

To sum up, it can be said that, for the logs \hat{1} to \hat{5}, the hacker themselves transmitted the ‘transmitted data part 21’ toward the data destination part 24’ by using a ‘transmission tool part 22’ called Havij, without passing through the ‘data originating part 24’ at all. Common characteristics of hacking attacks can be identified.

In contrast, for the logs \hat{6} to \hat{7}, the user used ‘transmission tool parts 22’ called Mozilla/5.0 (Windows NT 6.1; WOW64; rv:10.0) Gecko/20100101 Firefox/10.0 and Mozilla/5.0 (Windows NT 6.1; WOW64) AppleWebKit/535.7 (KHTML, like Gecko) Chrome/16.0.912.75 Safari/535.7 CoolNovo/2.0.0.9. That is, the ‘transmitted data part 21’ was transmitted using usual web browser tools called Firefox and CoolNovo (a multi-web browser allowing the use of both Explorer and Chrome), and both the ‘data originating part 23’ and the ‘data destination part 24’ were used.

To sum up, the logs \hat{6} to \hat{7} were created because a string pattern of traffic generated while the user was searching the web using a usual web browser tool incidentally matched a rule pattern. Common characteristics of non-attack logs can be identified.

As such, in the process of log analysis for a security system, it is important to understand the full meaning of the text of the attack content 20. In an exemplary embodiment of the present invention, string patterns of the attack content are displayed in table form by way of text normalization, and therefore the operator or log analyst does not need to locate a rule pattern, allowing them to understand the full meaning of the text of the attack content 20.

Meanwhile, if the attack content data is not based on a web request, the rule-pattern-based text normalization processor 63 performs normalization (S104). The rule pattern is a pattern defined by a rule that invokes the corresponding attack name. That is, attack content text is normalized based on a rule pattern. This will be described in detail below.

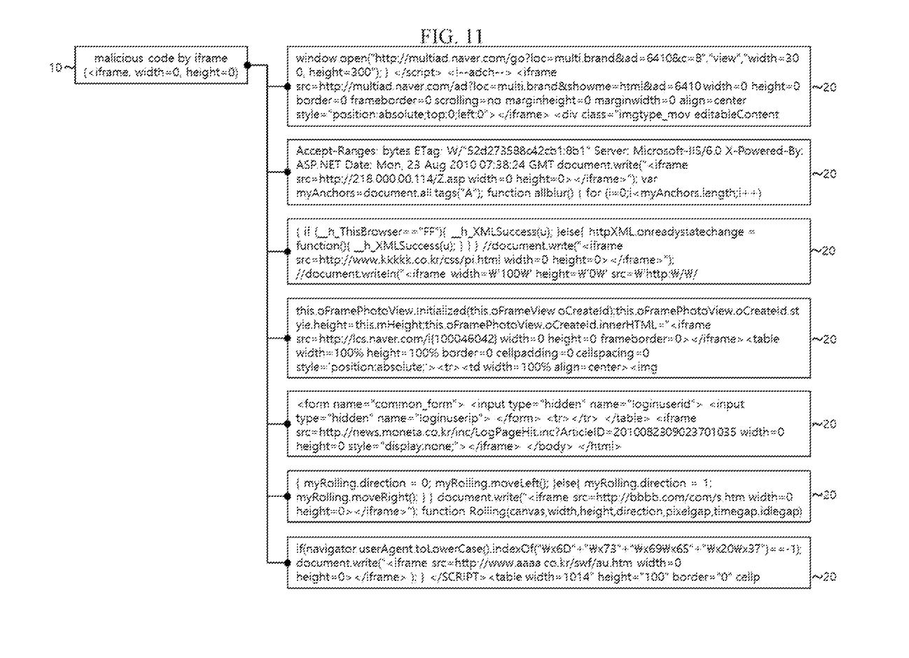

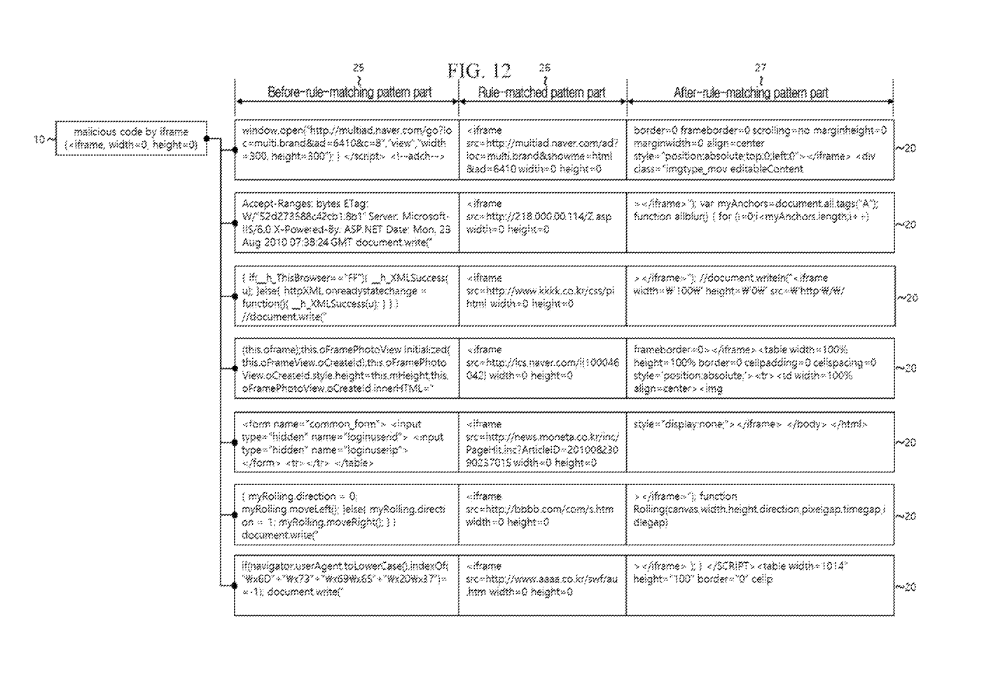

FIG. 11 and FIG. 12 show an exemplary embodiment in which a log is determined to have not been created during a web request process (S102), and then rule-pattern-based text normalization is performed without the process of HTTP-indicator-based text normalization (S103).

Referring to FIG. 11 and FIG. 12, the rule-pattern-based text normalization processor 63 normalizes the text of attack content normalized based on HTTP indicators into a before-rule-matching pattern part 25, a rule application pattern part 26, and an after-rule-matching pattern part 27, based on a rule pattern (S104), and an operator or log analyst makes a query about and analyzes logs of such formats as shown in FIG. 12, through the log screen 5.

Through this process, like in FIG. 10, it is possible to collectively check what meaning a specific rule pattern has in the entire attack content text.

As such, the above-described exemplary embodiments of the present invention allow for collective analysis of the meanings of rule patterns used for a huge amount of logs created in the security system 3 by classifying the text of attack content 20 of logs created in the security system 3 by attack name 10, i.e., performing text normalization, and also allow for intuitive differentiation between attack logs and non-attack logs by identifying common characteristics of the attack logs and common characteristics of the non-attack logs.

As explained above, according to a log analysis method according to the present invention which sorts attack content 20 by attack name 10 and performs text normalization, analysis amount and analysis speed can be improved, compared to the conventional method in which an operator or log analyst analyzes logs one by one.

Moreover, since the accuracy of a rule for monitoring hacking patterns can be quantitatively measured, the rule's accuracy can be improved based on the quantitative measurement (five out of seven logs shown in FIG. 10 are attacks, which gives quantitative rule accuracy measurement data stating that the rule is 71% accurate and 29% inaccurate).

The exemplary embodiments of the present invention are implemented not only through the apparatus and method, but may be implemented through a program that realizes functions corresponding to constituent members of the exemplary embodiments of the present invention or a recording medium in which the program is recorded. Such an implementation will be easily realized by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A log analysis system comprising:
a log database storing log information;
a security system that monitors communications between external general systems, generates the log information according to a predetermined rule of security, and stores the same in the log database;
a log analyzer that collects log information containing attack content from the log information stored in the log database, sorts the same by attack name, and if the attack content data is based on a web request, performs HTTP-indicator-based text normalization and then rule-pattern-based text normalization; and
a log screen that displays log information normalized by the log analyzer according to an administrator's request.

2. The log analysis system of claim 1, wherein if the attack content data is not based on a web request, the log analyzer performs rule-pattern-based text normalization.

3. The log analysis system of claim 2, wherein the log analyzer comprises:
a log collector that collects log information having attack content from the log information stored in the log database and sorts it by attack name;
an HTTP-indicator-based text normalization processor that, if the attack content data is based on a web request, performs HTTP-indicator-based text normalization; and
a rule-pattern-based text normalization processor that, if the attack content data is not based on a web request or the attack content data is normalized based on HTTP indicators, performs rule-pattern-based text normalization.

4. A log analysis system for a security system which analyzes logs the security system generates according to a predetermined rule and stores them in a log database, the log analysis system comprising;
a log analyzer that collects log information containing attack content from the log information stored in the log database, sorts the same by attack name, and if the attack content data is based on a web request, performs HTTP-indicator-based text normalization and then rule-pattern-based text normalization; and
a log screen that displays log information normalized by the log analyzer according to an administrator's request.

5. A log analysis method for a security system, which allows the security system monitoring communications between general systems to generate logs according to a predetermined rule and store the same in a log database, the log analysis method comprising:
determining whether log information containing attack content exists in the log database by a log analyzer;
if log information containing attack content exists, sorting the log information by attack name;
determining whether the attack content data of the log information sorted by attack name is based on a web request or not;
if the attack content data is based on a web request, performing lo HTTP-indicator-based text normalization; and
performing rule-pattern-based text normalization after the HTTP-indicator-based text normalization.

6. The log analysis method of claim 5, further comprising displaying log information normalized by the log analyzer according to an administrator's request.

7. The log analysis method of claim 6, further comprising, if the attack content data is not based on a web request, performing rule-pattern-based text normalization by a log analyzer.

8. The log analysis method of claim 7, wherein, in the performing of HTTP-indicator-based text normalization if the attack content data is based on a web request, the attack content data is normalized into URI, User-Agent, Referer, and Host based on HTTP indicators.
